(19) United States
(12) Patent Application Publication
(10) Pub. No.: US 2005/0110281 A1
(43) Pub. Date: May 26, 2005

(54) Hatch cover security system

(75) Inventor: Wayne Dykstra, Billings, MT (US)

Correspondence Address: JENKENS & GILCHRIST, 1401 MCKINNEY, SUITE 2600, HOUSTON, TX, 77010, US

(73) Assignee: ARC3 Corporation

(21) Appl. No.: 10/985,770

(22) Filed: Nov. 10, 2004

Related U.S. Application Data
(60) Provisional application No. 60/524,934, filed on Nov. 25, 2003.

(51) Int. Cl. E05C 19/18

(52) U.S. Cl. 292/260

(57) ABSTRACT

A hatch cover security system is described having two supports coupled to the structure, substantially diametrically opposite each other across the hatch opening. A restraining rail is adapted to be received by the supports and crosses the hatch cover. The restraining rail is adjustably coupled to the supports. The bar further includes a shield which covers a locking device.

### PRIOR RELATED APPLICATIONS

This patent application claims priority to U.S. Provisional Application Ser. No. 60/524,934, filed on Nov. 25, 2003, the disclosure of which is incorporated by reference in its entirety herein.

### FEDERALLY SPONSORED RESEARCH STATEMENT

Not applicable.

### REFERENCE TO MICROFICHE APPENDIX

Not applicable.

### FIELD OF THE INVENTION

The invention relates to a hatch cover security system. More particularly, the invention relates to an adjustable hatch cover locking device which provides exceptional security while being adjustable to meet the needs of changing regulatory requirements.

### BACKGROUND OF THE INVENTION

Tanks, buildings, railroad cars, tanker trucks, ships, and other infrastructure, structures, and transportation media which require access into their interiors through a hatch are subject to unauthorized entry by criminals. An even more compelling threat is posed by the possibility of sabotage by vandals or terrorists. Consumer products ranging from household cleaners to foods are stored in tanks and transported by tanker trucks and railcars. Sabotage may include, for example, introduction of liquids, gases or solids containing foulants or hazardous chemical, biological, or radiological agents into tanks, buildings, railroad cars, ships, and other infrastructure through these covers. For example, an unscrupulous business could intentionally contaminate a competitor's product, such as by introducing a foul odorant into a consumer product. Even more compelling, however, is the risk of terrorist activities which could threaten not only economic interests but also the health and life of the citizenry. For example, milk is often transported across large distances by tanker truck to a processing facility where it is processed and packaged before being shipped to, for example, groceries, restaurants and schools. Should a milk tanker truck hatch be breached by a saboteur to introduce a pathogen, a large number of people could be sickened or killed. Consequently, the security of hatches protecting goods intended to enter the stream of commerce is of paramount importance.

Moreover, many or most public and private buildings are on closed or semi-closed air conditioning and recirculation systems. One concern which has recently arisen is the possibility that terrorists might introduce pathogens or poisons into such air circulation systems. Such systems are frequently accessible by hatches or hatch-type opening or ports. Securing such hatches or openings is also of critical importance in deterring such terrorist acts.

Such hatches are typically covered by a fabricated lid hinged on one side and secured on the other side by a simple padlock hasp. The hasp or padlock may be easily defeated with a simple pry bar, either at the hasp or the padlock. Alternatively, hammers or other objects may be used to damage the hasp or padlock, thereby breaking open the locking mechanism. Moreover, because the hinge mechanism is exposed, it may also be violated by mechanical means. That is, one attempting to breach a hatch cover needs only simple, small, easily obtainable and easily concealed hand tools.

Another available design for securing a hatch cover is a simple bar design. A bar is positioned across the hatch and two tabs are welded onto the vessel or hatch flange at opposite positions across the hatch opening. The bar is inserted between the tabs. A padlock is inserted in an opening in the bar and through one of the tabs. Such bar designs, however, have a fixed height which prevents easy reinforcement or replacement of a damaged or deteriorated hatch cover and may also be easily defeated by hand tools. Furthermore, changing hatch cover regulations and requirements, two in the last ten years, also necessitate an adjustable system.

There remains a need, therefore, for a hatch cover security system which is not easily defeated by readily accessible and easily concealed tools. There remains a further need for a hatch cover security system which is adjustable to meet the needs of changing regulatory requirements.

### SUMMARY OF THE INVENTION

The invention to accomplish this protection is a security device for hatch covers located on tanks, buildings, railroad cars, ships, and other infrastructure. The security device may be an add-on fixture to existing hatch covers or as part of the hatch cover for a new structure. The configuration of the security device creates a secure environment, making it difficult for an intruder to have access to the hatch cover and the interior of the structure. The secure environment in the practice of this invention is created by the use of permanently attached rods, preferably threaded, diametrically opposite across the hatch cover. The rods, made from a high strength steel, allow a locking bar having openings to be placed onto the rods and across the hatch cover. The locking bar, or restraining rail, is adapted to provide a shrouded enclosure for the placement of a locking device. The shrouded enclosure is designed to make it difficult for intruders to use pry bars or bolt cutters on the locking device. The locking bar is adjustable along the rods, useful when regulations or requirements are changed. In an alternate embodiment, the security device may also include reinforcing bars coupled to the locking bar to reinforce damaged or deteriorated hatch covers.

Several other design factors are important. The security device of this invention does not compromise legitimate access to the hatch. This security device will be made of a material suitable for installation outdoors subject to typical weather conditions on existing or new structures without interfering with operations to the structure. Finally, the security device is readily detachable and reusable.

### BRIEF DESCRIPTION OF THE DRAWINGS

FIG. 1 is a preferred embodiment of the security hatch cover.

FIG. 2 is a side view of FIG. 1 along the hatch line 2

FIG. 3 is a side view of FIG. 1 along the hatch line 3

FIG. 4 is a top view of FIG. 1 of an alternate embodiment of the security hatch cover showing reinforcing rails in place.

### DESCRIPTION OF EMBODIMENTS OF THE INVENTION

Referring first to FIG. 1, a hatch generally comprises a hatch cover (200) covering an opening at the top of a hatch flange (400) attached to a structure or vessel (300) and extending outwardly from the outside or exterior surface of the structure or vessel (300). Hatch cover (200) is most frequently a simple disk-shaped lid but may also include more complicated shapes, such as a lid with a perpendicularly extending lip. The hatch cover security system (100) generally includes at least two supports (10 & 12) and a restraining rail (14).

A first support (10) is coupled or attached in any appropriate manner to the structure (300) adjacent to or near the junction of the hatch flange (400). A tamper-proof or tamper-resistant fastener (16) couples the first support (10) to the structure (300) and allows the first support (10) to be hingedly movable such that first support (10) may rotate from a position substantially perpendicular to the outside surface of the structure (300) to a position substantially parallel to the outside surface of the structure (300). A number of tamper-proof or tamper-resistant, hinged fasteners are known and any such fastener may be used in the invention. By allowing the first support (10) to rotate from about 0 to about 90 degrees relative to the outside surface of the structure, easier installation of the restraining rail (14) is possible. Because most hatch covers have a hinged lid, in some embodiments of the hatch cover security system, the first support (10) is located adjacent to that portion of the hatch flange on which the cover hinge is attached. The tamper-proof or tamper-resistant fastener (16) should be constructed to withstand acts of vandalism, especially unauthorized entry to the hatch. Such known tamper-resistant systems include, for example, those which use a screw or bolt having a head with an unusual shape or having an opening with an unusual shape for which specially manufactured tools are required to turn or open. Tamper-proof systems include those, for example, for which the screw or bolt head is enclosed in a solid sheath or which are permanently attached to the structure or which are unitarily molded with the structure. In some embodiments, the fastener (16) is welded or bolted to the structure (300). Alternatively, the tamper-proof or tamper-resistant fastener (16) may be fixedly attached to a base (600) which in turn is fixedly attached to the outside surface of the structure. Any of a number of known methods, including for example welding, may be used to fixedly attach the fastener (16) to the base (600) and the base (600) to the structure (300).

A coupling device (26) is adjustably attached to the first support (10) such that coupling device (26) may be adjusted along the length of the first support (10). In some embodiments, the first support (10) is a threaded rod, for example, a 1 inch threaded rod. The first support (10) should be constructed of an industrial grade high strength steel, such as that used for a grade 9 bolt, or 316 or 318 stainless steel. In such embodiments, the coupling device (26) may be a complimentarily threaded nut. Coupling device (26) may be adjusted to substantially any position along the length of first support (10).

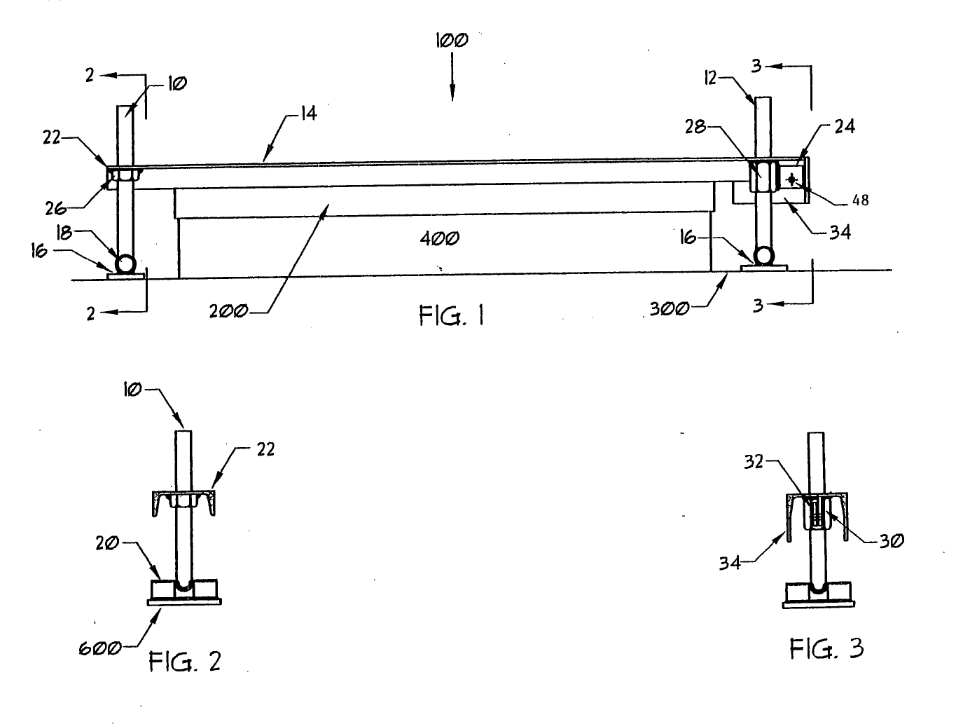

Referring now to FIG. 2, one embodiment of the fastener (16) and first support (10) assembly is shown. In this embodiment, fastener (16) includes at least two members (20) coupled to the structure (300) to form a substantially U-shaped channel. Members (20) may be of any shape such that a substantially U-shaped channel is formed by the junction of members (20) and the structure (300). For example, members (20) may be bars, rods or pipes. Alternatively, members (20) may have a substantially triangular cross-section. A rotator member (18) is attached to a bottom end of the first support (10). Rotator member (18) is hingedly secured within the U-shaped channel formed by members (20). Rotator member (18) may be unitarily formed as a part of first support (10) or alternatively, may be a separate piece which is fixedly attached to first support (10). In those embodiments in which rotator member (18) is a separate piece, it may be fixedly attached to first support (10) by any of a number of known means, such as by welding it to the first support (10). Rotator member (18) allows the first support (10) to rotate as described above, i.e. from a position substantially perpendicular to the outside surface of the structure (300) to a position substantially parallel to the outside surface of the structure. In some embodiments, rotator member (18) is a 1 inch diameter rod. In some embodiments, members (20) are pipes wherein the U-shaped channel is formed by facing the open ends of such pipes toward each other. In such embodiments, where rotator member (18) is a rod, the first support (10) may be held in place by inserting the ends of the rotator member (18) into the facing openings of members (20). This mode of attachment allows the first support (10) to rotate about the axis of the rotator member (18). Alternatively, where members (20) are formed of solid bars, rotator member (18), and first support (10), may be attached by passing a pin or rivet through each of members (20) and rotator member (18). Members (20) are fixedly attached to the structure (300) by any of a number of known means, including, for example, by welding. Alternatively, members (20) may be held in place by metal straps or U-bolts, which in turn may be fixedly attached to the structure (300), such as by welding.

A second support (12) is similarly attached to the structure (300) wherein the placement of the second support is substantially diametrically opposite the first support (10) across the hatch cover (200). The second support (12) should preferably be located at a sufficient distance from the hatch flange (400) to allow access to the opening at the top of the hatch flange (400). The second support (12) is coupled to the structure (300) by a tamper-proof or tamper-resistant fastener (16), as described above. Alternatively, the tamper-proof or tamper-resistant fastener (16) for the second support (12) may, or may not, be hingedly coupled to the structure but rather fixedly attached. In such non-hinged embodiments, care should be taken to locate the fastener, and thus the second support (12), sufficiently distant from hatch flange (400) to permit access to the opening at the top of the hatch flange (400). The second support (12) is adapted to allow a mating device (28) to be adjusted along its length, as described above in connection with first support (10). In some embodiments, the second support (12) is a threaded rod, such as a 1 inch threaded rod or bolt, also made of high strength steel, and the mating device (28) is a 1 inch nut.

A restraining rail (14) having a first end (22) and a second end (24) is oriented across the hatch to prevent access into the structure (300). The restraining rail (14) is longer than the diameter of the opening of hatch flange (400) and generally extends past the edges on both sides of the hatch cover (200). The restraining rail may be formed as an integral part of the hatch cover (200), but most often when retrofitting a structure with the security device of this invention will not be attached to the cover. In some embodiments, the restraining rail (14) is fabricated from U-channel steel beams. More preferably, the restraining rail (14) is a 4 inch by 5.4 inch U-channel steel beam. The first end (22) is adapted to receive the first support (10), generally through an opening (40) in the first end (22). Referring to FIG. 4, opening (40) is shown and is large enough to accommodate the first support (10), but not large enough for any stiff foreign object, such as a pry bar, to be inserted. Coupling device (26) is placed at an appropriate location along first support (10), such location being approximately where the restraining rail (14) will be placed to inhibit or block access to the hatch cover. Opening (40) in the first end (22) is placed around the first support (10) and the restraining rail (14) adjusted to a height which is sufficiently close to the hatch cover (200) to prevent access to the hatch cover (200). Restraining rail (14) may alternatively be placed directly on top of hatch cover 200. Where restraining rail (14) is a U-channel beam, the restraining rail (14) is placed such that the opening in the U-channel is facing toward the hatch cover (200) and structure (300). The hinged fastener (16) of the first support (10) allows for easy installation of the coupling device (26) and the first (22) end of the restraining rail (14) onto the first support (10) as well as easy adjustment of coupling device (26) by making access to the underside of the restraining rail (14) easier. When the first support (10) is a threaded rod, the coupling device (26) can be a nut which is the size to be screwed on the threaded rod. Once the desired location of the restraining rail (14) along the length of first support (10) is determined, coupling device (26) may be, in some embodiments, fixedly attached, such as by welding, to restraining rail (14). In a preferred embodiment, the coupling device (26) is a nut which is easily adjusted to vary the height of the restraining rail (14) relative to the hatch cover (200) such that it can be more universally used on structures with varying height hatches. The coupling device (26) can be adjusted before and/or after first support (10) is inserted through opening (40).

The second end (24) of the restraining rail (14) is adapted to receive the second support (12), generally through an opening (42) in the second end (24) of restraining rail (14), as shown in FIG. 4. Opening (42) is sized similarly to opening (40) so as to prevent insertion of a stiff object, such as a prybar, through opening (42) when second support (12) is inserted through opening (42). Generally following placement of the first end (22) of the restraining rail (14) over the first support (10), the second support (12) is placed through the opening (42) in the second end (24) of restraining rail (14). By placing the restraining rail (14) across the hatch cover (200), a barrier to opening the hatch cover (200) and therefore to accessing the interior of the structure (300) is formed. If the second support (12) is hingedly coupled to the structure, easier installation of the mating device (28) and the second end (24) of the restraining rail (14) onto the second support (12) is accommodated. If the second support is not hingedly coupled to the structure, the opening (42) in the second end (24) is adapted to accept the second rod (12) without undue stress. However, while the opening (42) should be large enough to accommodate the second support (12), it should not be large enough for any rigid foreign object, such as a pry bar, to be inserted into opening (42) when in position on the second support (12). Mating device (28) is adjusted along the length of second support (12) such that restraining rail (14) is at a height sufficiently close to the hatch cover (200) to prevent opening the hatch cover (200). The mating device (28) can be adjusted before and/or after opening (42) in restraining rail (14) is placed around second support (12). Alternatively, restraining rail (14) may be placed directly in contact with the hatch cover (200). In a preferred embodiment, the mating device (28) is a barrel nut which is easily adjusted to vary the height of the restraining rail (14) relative to the hatch cover (200) such that it can be more universally used on structures with varying height hatches. When the second support (12) is a threaded rod, the mating device (28) may be a barrel nut.

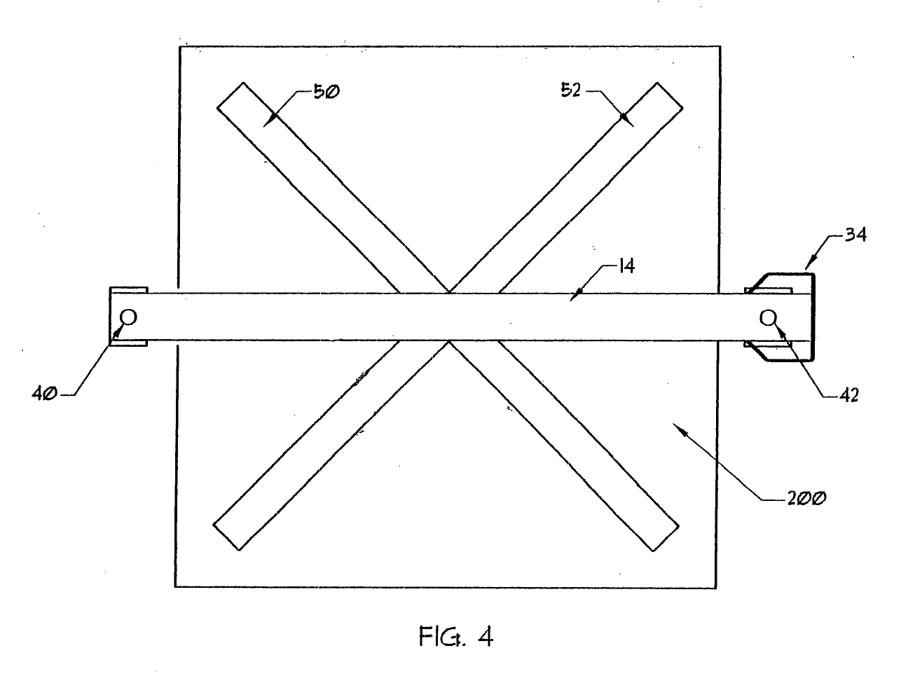

Referring now to FIG. 3, in some embodiments, the underside of the second end (24) of the restraining rail (14) further includes a tab (30). In such embodiments, the mating device (28) is adapted to further include a tab (32) extending from the outer surface of mating device (28). Tabs (30 & 32) are constructed to be interlocking or interconnecting when the restraining rail is in position. The joining of the tabs can be as simple as aligning the tabs, thereby forming a lock opening (48). The tabs may also have some sort of snapping or “click-together” mechanism for a first level of security. That is, tabs (30 & 32) are mechanical means that provide another mechanism for securing the restraining rail (14) to the structure (300). In some embodiments, tabs (30 & 32) are 3/16 inch tabs constructed of steel or other suitable metal and are welded to the restraining rail and the mating device, respectively.

Restraining rail (14) further includes a shield (34). The shield wraps around the two sides and end portion of the second end (24) so as to shroud the lock opening formed by the tabs (30 & 32). The shield (34) may be either unitarily formed with restraining rail (14) or alternatively, may be fixedly attached to restraining rail (14), for example, by welding. The shield (34) extends downward a sufficient distance to cover the second end (24) of the restraining rail (14), including the tabs (30 & 32) and mating device (28). In a preferred embodiment, the shield (34) is made up of three 3/16″ tabs coupled to form a U around the second end (24) of restraining rail (14). Shield (34) provides yet another level of security by further blocking access to the lock opening (48).

In some embodiments, tabs (30 & 32) of the restraining rail (14) and the mating device (28), respectively, are further coupled by a locking mechanism. For example, in such embodiments, tabs (30 & 32) may have openings which align upon installation of the second end (24) of the restraining rail (14) onto second support (12) thereby forming the lock opening (48) through which a padlock may be placed. Alternatively, tabs (30 & 32) may be constructed so as to form a interconnecting locking components wherein the locking mechanism is part of tabs (30 & 32). In preferred embodiments, the locking mechanism is also shrouded by shield (34).

Referring now to FIG. 4, yet another embodiment of the hatch cover security system is shown. In this alternate embodiment, restraining rail (14) further includes at least two reinforcing restraining rails. A first reinforcing restraining rail (50) and a second reinforcing restraining rail (52) are adapted to be coupled to the restraining rail (14). Preferably, the first reinforcing restraining rail (50) and second reinforcing restraining rail (52) are orientated to form an “X” and sized to extend to at least the edge of the hatch cover (200). In some embodiments, the first reinforcing restraining rail (50) and second reinforcing restraining rail (52) are fixedly attached to the underside of the restraining rail (14) to reinforce the hatch cover. Alternatively, the reinforcing restraining rails (50 & 52) are fixedly attached directly to the top of the hatch cover (200). Reinforcing restraining rails (50 & 52) may be fixedly attached to either restraining rail (14) or hatch cover (200) using any of a number of known methods, including, for example, welding. In one preferred embodiment, the reinforcing restraining rails (50 & 52) are fabricated from U-channel steel beams. In other preferred embodiments, more than two reinforcing restraining rails are present. The reinforcing restraining rails add yet another level of security by preventing access to the contents of the structure or vessel by prying the hatch cover (200). Depending upon the material of construction of the hatch cover (200) and the ease with which the hatch cover (200) may be pried up and away from the top of the hatch flange, two or more reinforcing restraining rails may be utilized.

The components of the hatch cover security system (100), including first and second supports (10 & 12), restraining rail (14), reinforcing restraining rails (50 & 52), and shield (34) may be made from any suitably rigid, strong, and durable material, including, for example, stainless steel (such as 308 or 316 stainless steel) or powder coated high strength carbon steel. These high strength steels normally yield only to a cutting torch without great difficulty. Such steel is well known to the skilled manufacturer. Other materials having sufficient strength to resist prying and tampering as well as weather resistance, such as carbon fiber reinforced composites, may also be used. For corrosive environments, materials that are corrosion resistant, such as a stainless steel core coated with a polymeric substance, can be used. In preferred embodiment, the components of the hatch cover security system (100) are made of powder coated high strength carbon steel. The hatch cover security system (100) may be retrofitted onto an existing hatch cover or alternatively, may be made as an integral part of new hatches and hatch covers.

The structure or vessel (300) may be any structure that provides access into the interior of the structure through a hatch-like opening. Examples of such structures include, but are not limited to, storage, processing and transfer tanks (i.e., chemical, petroleum, water, storage, etc.), buildings, railroad cars, tank trucks, ships, building air circulation systems, ship holds, and underground storage tanks. Furthermore, the hatch cover security system (100) does not have to be used on hatch covers exclusively. Any structure with an opening that requires limited access is a candidate for the hatch cover security system (100). Moreover, the invention may be utilized with openings or hatches which are flush with the outer surface of the structure or vessel and for which there is no or almost no hatch flange.

The orientation of the hatch cover security system (100) may be horizontal or vertical or any orientation necessary depending upon the orientation of the hatch (400) being protected.

Having now described the invention in particularity it is respectfully pointed out that those of ordinary skill in the art will be able to make many modifications and variations of the same without departing from the construction of the appended claims.

1) A hatch cover security system for a hatch cover on a structure comprising
a) a first support hingedly attached to the structure adjacent to the hatch to which the security system is to be attached,
b) a second support attached to the structure substantially opposite the first support across the hatch wherein the first support and the second support are made of powder coated high strength carbon steel or stainless steel,
c) a restraining rail oriented across the hatch to prevent access into the structure when in a hatch securing position comprising,
i) a first end of the restraining rail having a hole for receiving the first support and oriented to secure the first end of the restraining rail to the structure, and
ii) a second end of the restraining rail having a hole for receiving the second support and oriented to secure the second end of the restraining rail to the structure;
d) a coupling means adapted to couple the first support and the bottom of the first end of the restraining rail;
e) a mating device coupling the second support and the bottom of the second end of the restraining rail;
f) a pair of tabs with mating openings to receive a locking device when the second end of the restraining rail is in the hatch securing position comprising,
i) a first tab attached to, and extending from, the bottom of the second end of the restraining rail, and
ii) a second tab carried by the mating device, and
g) a shield coupled to the restraining rail at the second end to shroud the mated tabs, preventing access to a locking device in the mated openings.

2) The hatch cover security system of claim (1) wherein the first support is a threaded rod.

3) The hatch cover security system of claim (1) wherein the second support is a threaded rod.

4) The hatch cover security system of claim (1) wherein the second support is hingedly coupled to the structure.

5) The hatch cover security system of claim (1) wherein the hinged coupling is tamper-proof.

6) The hatch cover security system of claim (1) wherein the restraining rail is made of U-channel powder coated high strength carbon steel or stainless steel.

7) The hatch cover security system of claim (1) wherein the restraining rail contacts the hatch cover.

8) The hatch cover security system of claim (1) wherein the coupling device is a nut.

9) The hatch cover security system of claim (1) wherein the mating device is a barrel nut.

10) The hatch cover security system of claim (1) wherein the locking device is a padlock.

11) The hatch cover security system of claim (1) further comprising at least two reinforcing restraining rails coupled to the bottom of the restraining rail and positioned to form an X across the hatch cover.

12) The hatch cover security system of claim (11) wherein the at least two reinforcing restraining rails are welded to the bottom of the restraining rail.

13) The hatch cover security system of claim (8) wherein the nut is further welded to the restraining rail.

14) A security device for a hatch cover on a structure comprising
a) a first threaded support tamper-proof hingedly coupled by welds or permanent bolts to the structure and made of powder coated high strength carbon steel or stainless steel,
b) a second threaded support tamper-proof hingedly coupled by welds or permanent bolts to the structure opposing the first support across the hatch, made of powder coated high strength carbon steel or stainless steel;
c) a restraining rail of U-channel powder coated high strength carbon steel or stainless steel adjustably oriented across the hatch to prevent access into the structure and contacting the cover comprising,
i) a first end of the restraining rail having a hole for receiving the first support and oriented to secure the first end of the restraining rail to the support,
ii) a second end of the restraining rail having a hole for receiving the second support substantially diametrically oriented to the first support across the hatch to secure the second end of the restraining rail to the support in a position to prevent access to the interior of the structure through the hatch.
d) a nut adapted to adjustably couple the first support and the first end of the restraining rail,
e) a barrel nut adjustably coupling the second support and the second end of the restraining rail;
f) a pair of locking tabs which mate to form an opening comprising,
i) a first lock tab welded to the bottom of the second end of the restraining rail, and
ii) a second lock tab fixed on the barrel nut, capable of receiving a padlock shackle inserted through the opening when the tabs are mated; and
g) a shield carried by the restraining rail to shroud the lock tabs and prevent access to a padlock when present.
